(19) United States
(12) Patent Application Publication
(10) Pub. No.: US 2008/0209080 A1
(43) Pub. Date: Aug. 28, 2008

(54) COMPUTER SYSTEM AND CONTROL METHOD THEREOF

(75) Inventors: Jong-ho SONG, Suwon-si (KR); Jun-young Jung, Seoul (KR); Hee-Keun Park, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/942,074

(22) Filed: Nov. 19, 2007

(30) Foreign Application Priority Data
Feb. 23, 2007 (KR) 2007-18293

(51) Int. Cl. G06F 3/00; G09G 5/08

(52) U.S. Cl. 710/14; 345/156; 345/157

(57) ABSTRACT

A computer system include an operation performing unit which performs at least one operation, a manipulation information producing unit which senses user's manipulation to produce direction information and motion amount information corresponding to an amount of motion in a direction corresponding to the direction information, a mode selection unit which inputs user's selection about a manipulation mode, and a controller which controls the operation performing unit based on the direction information which is produced by the manipulation information producing unit, or controls the operation performing unit based on the direction information and the motion amount information, according to the user's selection inputted through the mode selection unit.

### CROSS-REFERENCE TO RELATED APPLICATIONS

This application claims the benefit of Korean Patent Application No. 10-2007-0018293, filed on Feb. 23, 2007, in the Korean Intellectual Property Office, the disclosure of which is incorporated herein by reference.

### BACKGROUND OF THE INVENTION

1. Field of the Invention

The present general inventive concept relates to a computer system and a control method thereof, and more particularly, to a computer system and a control method thereof, which perform an operation according to a direction and an amount of user manipulating motion.

2. Description of the Related Art

A computer system such as a desktop computer and a notebook computer performs an operation according to user's manipulation. For example, the computer system indicates a pointer or a cursor on a screen and controls the pointer or cursor to move according to a user's manipulation.

Thus, to perform an operation according to a user's manipulation, the computer system includes an information producing unit (which is referred to as a manipulation information producing unit) which produces information corresponding to a user's manipulation.

The conventional manipulation information producing unit can be classified into two forms. For example, one is a unit (hereinafter called “direction keys”) which produces information (hereinafter called “direction information”) indicating to which direction a user's manipulation directs, like four direction keys on a keyboard, and the other is a unit (hereinafter called a “pointing device”) which produces information (hereinafter called a “motion amount information”) indicating to which direction and how far a user's manipulation directs and moves like a mouse or a pointing stick.

In many cases, the conventional computer system includes both the direction keys and the pointing device. However, with some computer systems, it may be difficulty to include the direction keys and the pointing device, due to spatial restriction or layout design of the computer system. For example, such a case is a tiny mobile computer.

### SUMMARY OF THE INVENTION

Accordingly, it is an aspect of the present general inventive concept to provide a computer system and a control method thereof, including at least one manipulation information producing unit to obtain various kinds of the manipulation information.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a computer system including an operation performing unit which performs at least one operation, a manipulation information producing unit which senses a user's manipulation to produce a direction information and a motion amount information in a direction corresponding to the direction information, a mode selection unit which inputs a user's selection about a manipulation mode, and a controller which controls the operation performing unit based on the direction information which is produced by the manipulation information producing unit, or controls the operation performing unit based on the direction information and the motion amount information, according to the user's selection inputted through the mode selection unit.

The manipulation information producing unit may output a first information signal including the direction information and the motion amount information and a second information signal including the direction information and the motion amount information that has a signal standard different from the first information signal, and wherein the controller controls the operation performing unit based on the direction information included in the first information signal, or controls the operation performing unit based on the direction information and the motion amount information included in the second information signal.

The controller may include an operation controller which controls the operation performing unit, and an information processor which extracts the direction information included in the first information signal to thus transmit the extracted direction information to the operation controller, or transfers the direction information and the motion amount information included in the second information signal to the operation controller.

The manipulation information producing unit may include a sensor which senses the user's manipulation, a signal producer which produces the first information signal based on the sensor's sensed result, and a signal converter which converts the first information signal produced by the signal producer into the second information signal.

The signal producer may transmit a first interrupt signal to the signal converter and the information processor, and any one of the signal converter and the information processor receives the first information signal from the signal producer if the first interrupt signal is transmitted from the signal producer.

The information processor may transmit a second interrupt signal to the signal converter in the case that the user's selection input by the mode selection unit corresponds to transmission of the second information signal, and the signal converter transmits the second information signal to the information processor if the second interrupt signal has been transmitted from the information processor.

The first information signal may be transmitted between the signal producer and the signal converter, and between the signal producer and the information processor following an Inter-Integrated Circuit (I2C) standard.

The second information signal may be transmitted between the signal converter and the information processor following a PS/2 standard.

The manipulation mode may include a direction key mode and a pointing device mode, and the controller controls the operation performing unit based on the direction information if the direction key mode is selected, and controls the operation performing unit based on the direction information and the motion amount information if the pointing device mode is selected.

The foregoing and/or other aspects and utilities of the present general inventive concept may also be achieved by providing a control method of controlling a computer system including an operation performing unit which performs at least one operation, and a manipulation information producing unit which senses a user's manipulation to thus produce a direction information and a motion amount information in a direction corresponding to the direction information, the control method including confirming whether a user's selection is inputted with respect to a manipulation mode, and controlling the operation performing unit based on the direction information or based on the direction information and the motion amount information, which are respectively produced by the manipulation information producing unit according to the user's selections.

The manipulation information producing unit may output a first information signal including the direction information and the motion amount information and a second information signal including the direction information and the motion amount information that has a signal standard different from the first information signal, and the operation of controlling includes controlling the operation performing unit based on the direction information included in the first information signal, or controlling the operation performing unit based on the direction information and the motion amount information included in the second information signal.

The operation of controlling may include an operation of receiving the first information signal from the manipulation information producing unit following an Inter-Integrated Circuit (I2C) standard.

The operation of controlling may include an operation of receiving the second information signal from the manipulation information producing unit following a PS/2 standard.

The operation of controlling may further include an operation of controlling the manipulation information producing unit so that the second information signal can be selectively transmitted according to the input user's selection.

The manipulation mode may include a direction key mode and a pointing device mode, and the operation of controlling includes controlling the operation performing unit based on the direction information if the direction key mode is selected, and controlling the operation performing unit based on the direction information and the motion amount information if the pointing device mode is selected.

The foregoing and/or other aspects and utilities of the present general inventive concept may also be achieved by providing a computer comprising a pointer device having an input which receives a physical manipulation by a user and having an output of manipulation data including direction information of a direction and information of an amount of the physical manipulation by a user, an input to receive at least first and second mode selections by a user, and a controller responsive to the mode selection received by the input and having an output to control a controlled device in communication with the controller in a first mode when the input receives the first mode selection and to control the controlled device in a second mode when the input receives the second mode selection.

The foregoing and/or other aspects and utilities of the present general inventive concept may also be achieved by providing a method of controlling a display, comprising physically interacting with a device, generating direction information and magnitude information corresponding to the physical interaction of the device, and in a first mode of operation, altering the display in response to the direction information, and in second mode of operation, altering the display in response to both the direction information and magnitude information, wherein in the first mode, the display is unresponsive to the magnitude information.

### BRIEF DESCRIPTION OF THE DRAWINGS

The above and/or other aspects of the present general inventive concept will become apparent and more readily appreciated from the following description of the embodiments, taken in conjunction with the accompanying drawings in which:

FIG. 1 is a block diagram illustrating a structure of a computer system according to an exemplary embodiment;

FIG. 2 is a block diagram illustrating a detailed structure of a computer system according to an exemplary embodiment;

FIG. 3 illustrates a data structure of a first information signal according to an exemplary embodiment;

FIG. 4 illustrates a data structure of a second information signal according to an exemplary embodiment;

FIG. 5 is a block diagram illustrating a detailed structure of an operation control unit according to an exemplary embodiment; and

FIG. 6 is a flowchart illustrating a control method of a computer system according to an exemplary embodiment.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

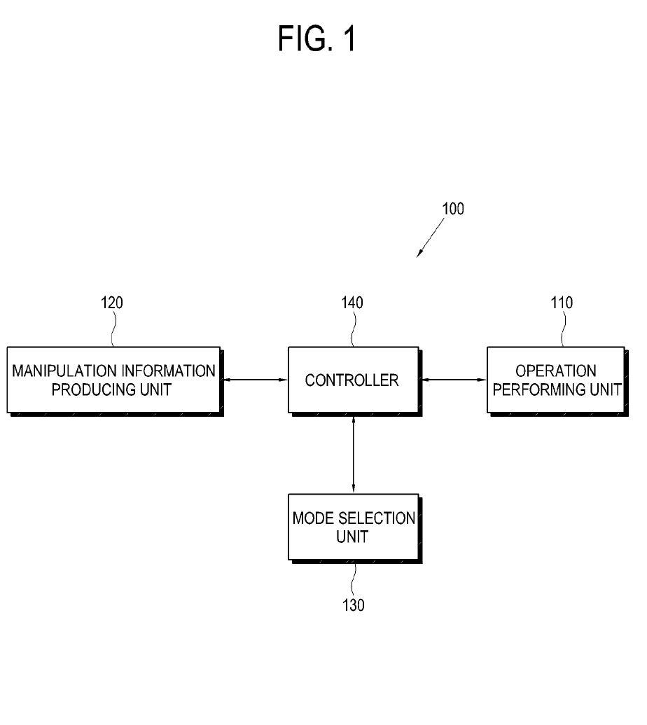

FIG. 1 is a block diagram illustrating a structure of a computer system according to an exemplary embodiment. A computer system 100 of FIG. 1 includes an operation performing unit 110, a manipulation information producing unit 120, a mode selection unit 130, and a controller 140. The manipulation information producing unit 120 may be, for example, a track ball, pointing stick, mouse touchpad, light pen, a touchscreen, a digitizing tablet, etc. The computer system 100 may be a mobile computer able to be carried.

The operation performing unit 110 performs at least one operation under the control of the controller 140. The operation performing unit 110 may perform the operations of a screen display, an audio output, etc. For example, the operation performing unit 110 can display a pointer or cursor on a display screen, and controls the pointer or cursor to move under the control of the controller 140.

The manipulation information producing unit 120 is a unit which, through sensing a user's manipulation, produces manipulation information reflecting direction information and a motion amount information reflecting an amount of motion in a direction corresponding to the direction information.

The mode selection unit 130 receives the user's selection of a manipulation mode. In this example, whether the motion amount information produced by the manipulation information producing unit 120 will be used as part of the manipulation information is determined according to the manipulation mode selected by a user.

The controller 140 controls the operation performing unit 110 based on only the direction information produced by the manipulation information producing unit 120, or controls the operation performing unit 110 based on both the direction information and the motion amount information, according to the manipulation mode selected by the user.

For example, the manipulation mode includes a direction key mode and a pointing device mode. The controller 140 controls the operation performing unit 110, based on only the direction information which has been produced by the manipulation information producing unit 120 in the case that the direction key mode is selected. Alternatively, the controller 140 controls the operation performing unit 110, based on both the direction information and the motion amount information produced by the manipulation information producing unit 120 in the case that the pointing device mode is selected.

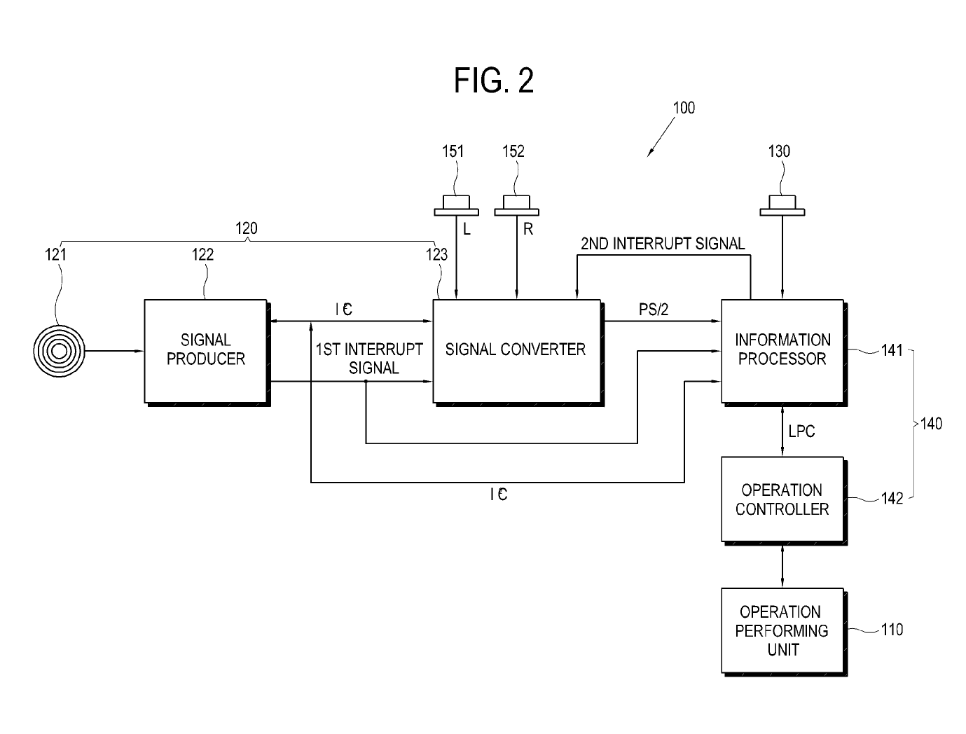

FIG. 2 is a block diagram illustrating a detailed structure of the computer system 100 of FIG. 1 according to an exemplary embodiment. The manipulation information producing unit 120 may output a first information signal that includes the direction information and the motion amount information and a second information signal that also includes the direction information and the motion amount information but having a signal format different from the first information signal format.

The controller 140 may control the operation performing unit 110 based on the direction information included in the first information signal in the direction key mode, and control the operation performing unit 110 based on the direction information and the motion amount information included in the second information signal in the pointing device mode.

As illustrated in FIG. 2, the controller 140 may include an operation controller 142 and an information processor 141. The operation controller 142 controls the operation performing unit 110. The information processor 141 extracts the direction information included in the first information signal to thus transmit the extracted direction information to the operation controller 142 when in the direction key mode, and transfers the direction information and the motion amount information included in the second information signal to the operation controller 142 when in the pointing device mode.

As illustrated in FIG. 2, the manipulation information producing unit 120 may include a sensor 121, a signal producer 122, and a signal converter 123. The sensor 121 senses the user's manipulation. The sensor 121 includes a manipulator (not shown) and senses x-directional and y-directional movements of the manipulator according to user's manipulation.

The signal producer 122 produces the first information signal based on the result sensed by the sensor 121. The signal converter 123 converts the first information signal produced by the signal producer 122 into the second information signal.

The signal producer 122 may transmit a first interrupt signal to the signal converter 123 and the information processor 141 in order to output the produced first information signal. Any one of the signal converter 123 and the information processor 141 may receive the first information signal from the signal producer 122 when the first interrupt signal is transmitted from the signal producer 122.

Standards for the first information signal and the second information signal include an Inter-Integrated Circuit (I2C) standard and a PS/2 standard. For example, transmission of the first information signal between the signal producer 122 and the signal converter 123 and between the signal producer 122 and the information processor 141 may follow the Inter-Integrated Circuit (I2C) standard, and transmission of the second information signal between the signal converter 123 and the information processor 141 may follow the PS/2 standard.

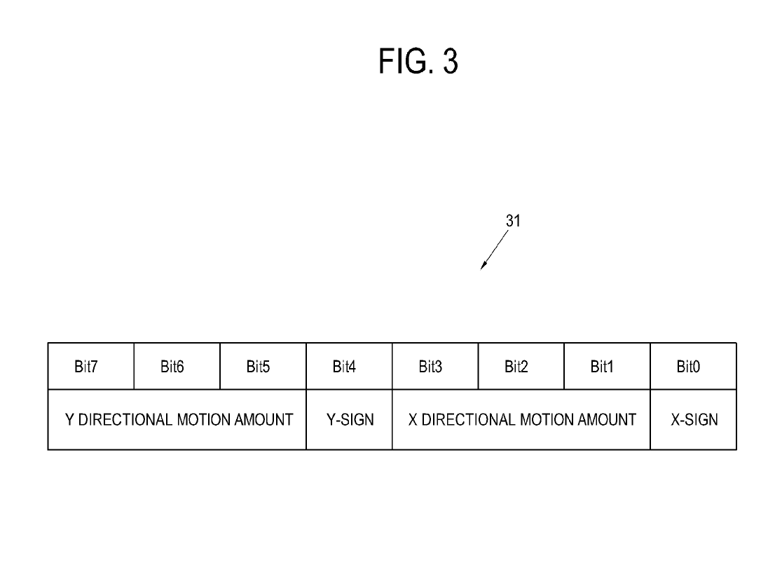

FIG. 3 illustrates an example of a data structure 31 of the first information signal which is transmitted according to the I2C standard. The first information signal may be composed of 8 bits. As direction information, ‘Bit0’ indicates an x-sign, and ‘Bit4’ indicates a y-sign. As motion amount information, ‘Bit1’ through ‘Bit3’ indicate an x-directional motion amount, and ‘Bit5’ through ‘Bit7’ indicate a y-direction motion amount.

The information processor 141 extracts the direction information from the first information signal transmitted according to the I2C standard in case of a direction key mode, to thus transmit the extracted direction information to the operation controller 142. The direction information which is transmitted from the information processor 141 to the operation controller 142 may be, for example, 4-direction or 8-direction information, etc.

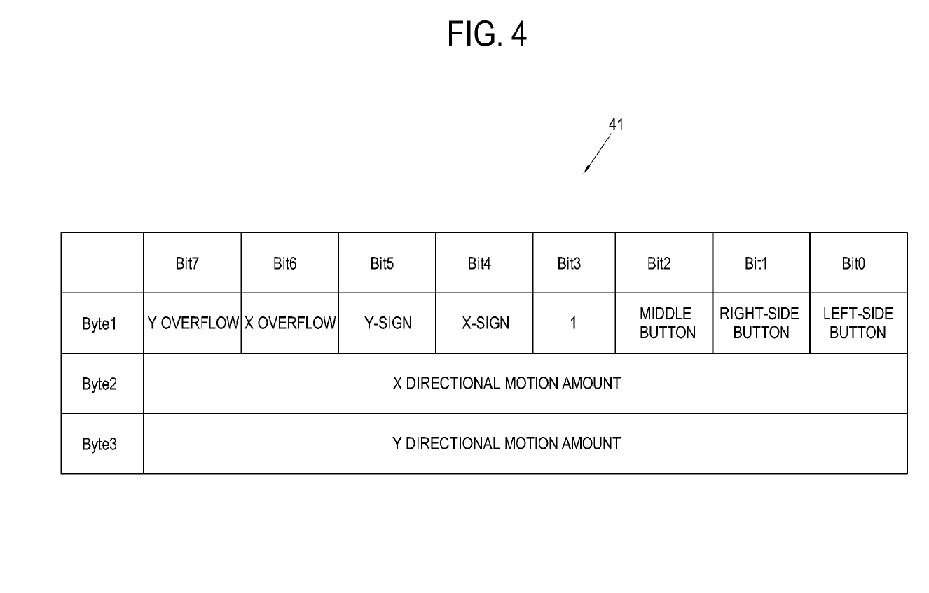

FIG. 4 illustrates an example of a data structure 41 of the second information signal transmitted according to the PS/2 standard. The second information signal may be composed of 3 bytes. As direction information, ‘Bit4’ and ‘Bit5’ of ‘Byte1’ indicate an x-sign and a y-sign, respectively. As motion amount information, ‘Byte2’ and ‘Byte3’ indicate an x-directional motion amount and a y-direction motion amount, respectively.

The information processor 141 may transfer the direction information and the motion amount information included in the second information signal transmitted according to the PS/2 standard to the operation control unit 142 as it was transmitted in case of the pointing device mode.

Transmission of a signal between the information processor 141 and the operation controller 142 may be performed according to a Low Pin Count (LPC) bus standard.

The mode selection unit 130 may include a button as illustrated in FIG. 2. The information processor 141 may alternate between processing the first information signal and the second information signal whenever the button of the mode selection unit 130 is pressed.

The information processor 141 may control the signal converter 123 to transmit the second information signal selectively according to user's selection input through the mode selection unit 130. For example, the information processor 141 monitors a state of the button of the mode selection unit 130, and transfers the second interrupt signal to the signal converter 123 if the pointing device mode is selected. In response, the signal converter 123 that received the second interrupt signal transmits the second information signal to the information processor 141.

Meanwhile, the second information signal is not transmitted from the signal converter 123 to the information processor 141 if the direction key mode is selected. An error which may occur by receiving the first information signal and the second information signal at the same time in the information processor 141 can be prevented by delaying a data transmission from the signal converter 123 since the second information signal will not be transmitted if the direction key mode is selected.

The computer system 100 may further include two auxiliary buttons 151 and 152 which play the role of the left-side button and the right-side button of a mouse. The signal converter 123 monitors states of the two auxiliary buttons 151 and 152 and transmits a monitoring result signal to the information processor 141. The operation controller 142 controls the operation performing unit 110 according to the states of the two auxiliary buttons 151 and 152 which are transmitted from the signal converter 123 via the information processor 141 when in the pointing device mode.

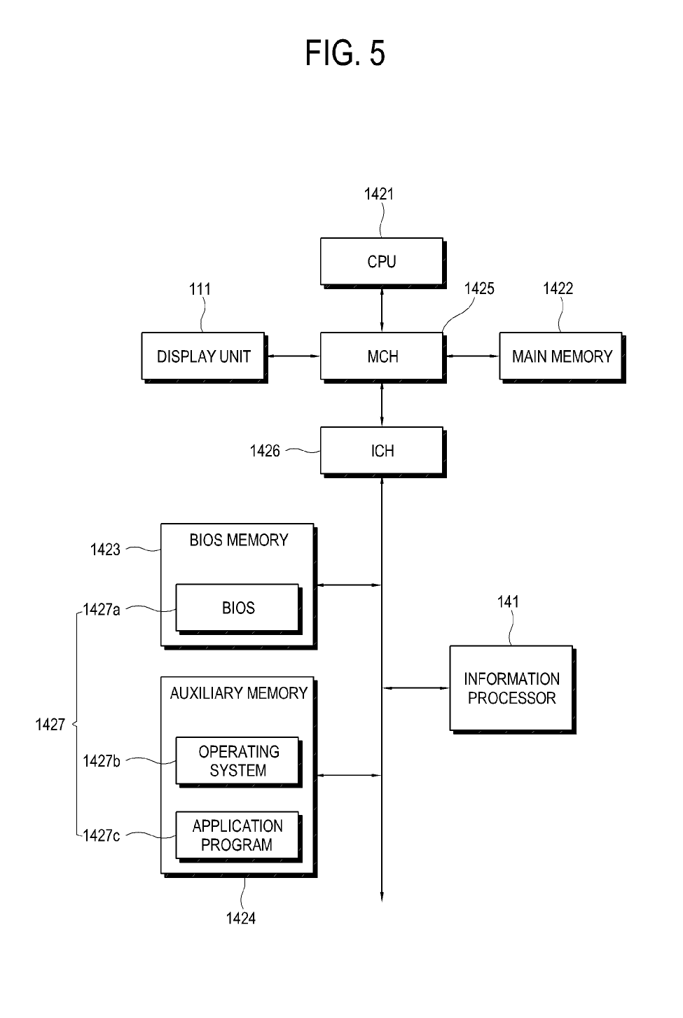

FIG. 5 is a block diagram illustrating a detailed structure of the operation controller 142 according to an exemplary embodiment. The operation controller 142 may be implemented by a combination of hardware and software (hereinafter referred to as a “computer program”) elements. In this example, hardware elements of operation controller 142 include a Central Processing Unit (CPU) 1421, a main memory 1422, a Basic Input/Output System (BIOS) 1423, an auxiliary memory 1424, a Memory Controller Hub (MCH) 1425 and a I/O Controller Hub (ICH) 1426.

In this example, the main memory 1422 is a volatile memory, for example, a Random Access Memory (RAM), and the BIOS memory 1423 is a non-volatile memory, for example, a Read Only Memory (ROM). The auxiliary memory 1424 may be a non-volatile memory, for example, a hard disc drive (HDD).

The Memory Controller Hub (MCH) 1425 is a high speed data transmission interface between the CPU 1421, the main memory 1422 and a display unit 111. The display unit 111 is an example of the operation performing unit 110, and may be implemented by a combination of a graphic processor and a liquid crystal display (LCD). The I/O Controller Hub (ICH) 1426 is a low speed data transmission interface between the MCH 1425, the BIOS memory 1423, the auxiliary memory 1424 and the information processor 141.

The operation controller 142 includes a computer program 1427, and may contain a Basic Input/Output System (BIOS) 1427a, an operating system (OS) 1427b, and an application program 1427c. The Basic Input/Output System (BIOS) 1427a is stored in the BIOS memory 1423, and the operating system 1427b and the application program 1427c may be stored in the auxiliary memory 1424.

The computer program 1427 may be composed of a series of codes which can be executed by the CPU 1421. When the computer program 1427 is executed by the CPU 1421, the whole or some of the computer program 1427 are loaded into the main memory 1422. The CPU 1421 reads and executes the codes of the computer program 1427 loaded into the main memory 1422, to thereby perform a function of the computer program 1427.

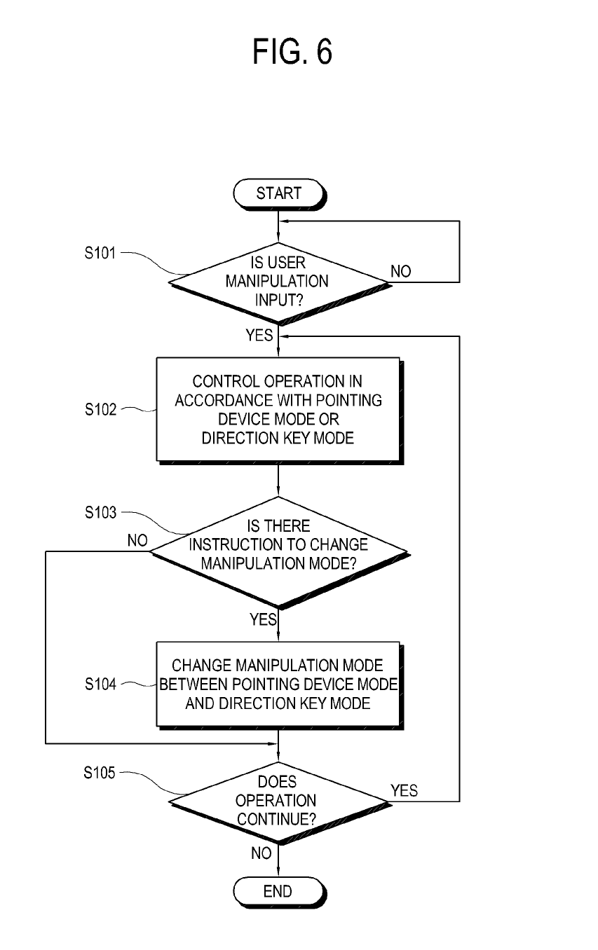

FIG. 6 is a flowchart view illustrating a control method of controlling the computer system 100 according to an exemplary embodiment. First, the control unit 140 confirms whether a user's manipulation is input via the manipulation information producing unit 120 (operation S101).

If it is determined that the user's manipulation is input in operation S101, the controller 140 controls the operation performing unit 110 in accordance with a pointing device mode or a direction key mode, based on the direction information and the motion amount information produced by the manipulation information producing unit 120 (operation S102).

Next, the control unit 140 confirms whether a user's instruction to change between the pointing device mode and the direction key mode is input via the mode selection unit 130 (operation S103). If the user's mode conversion instruction has been input in operation S103, the manipulation mode is switched in operation S104 (from the pointing device mode to the direction key mode, or vice versa). If the user's mode conversion instruction has not been input in operation S103, the method continues to operation S105.

Next, in operation S105, it is determined whether an operation of the operation performing unit 110 continues. If it is determined that the operation continues, the method proceeds to operation S102. If it is determined that the operation does not continue, the operations are terminated.

As described above, a computer system and a control method thereof, which can addresses spatial restrictions of the conventional computer system which should include a variety of manipulation information producing units to produce various kinds of corresponding manipulation information.

Here, a single unit can play a role of a direction key or a pointing device selectively. Also, an error which may be caused by receiving the two kinds of information at the same time can be prevented by delaying the output of the translated manipulation information (in the above example, by delaying the second information signal).

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents. As used in this disclosure, the term “preferably” is non-exclusive and means “preferably, but not limited to.” Terms in the claims should be given their broadest interpretation consistent with the general inventive concept as set forth in this description. For example, the terms “coupled” and “connect” (and derivations thereof) are used to connote both direct and indirect connections/couplings. As another example, “having” and “including”, derivatives thereof and similar transition terms or phrases are used synonymously with “comprising” (i.e., all are considered “open ended” terms)—only the phrases “consisting of” and “consisting essentially of” should be considered as “close ended”. Claims are not intended to be interpreted under 112 sixth paragraph unless the phrase “means for” and an associated function appear in a claim and the claim fails to recite sufficient structure to perform such function.

What is claimed is:

1. A computer system comprising:
an operation performing unit to perform at least one operation;
a manipulation information producing unit which senses a user's manipulation to produce direction information and motion amount information reflecting a motion amount in a direction corresponding to the direction information;
a mode selection unit which inputs a user's selection about a manipulation mode; and
a controller which controls the operation performing unit based on the direction information and disregards the motion amount information which is produced by the manipulation information producing unit, or controls the operation performing unit based on the direction information and the motion amount information, according to the user's selection inputted through the mode selection unit.

2. The computer system according to claim 1, wherein the manipulation information producing unit outputs a first information signal including the direction information and the motion amount information and a second information signal including the direction information and the motion amount information in a format different from a format of the first information signal, and wherein
the controller controls the operation performing unit based on the direction information included in the first information signal and disregards the motion amount information in the first information signal, or controls the operation performing unit based on the direction information and the motion amount information included in the second information signal.

3. The computer system according to claim 2, wherein the controller comprises:
an operation controller to control the operation performing unit; and
an information processor to extract the direction information included in the first information signal to thus transmit the extracted direction information to the operation controller, or to transfer the direction information and the motion amount information included in the second information signal to the operation controller.

4. The computer system according to claim 2, wherein the manipulation information producing unit comprises:
a sensor to sense the user's manipulation; a
a signal producer to produce the first information signal based on the sensor's sensed result; and
a signal converter to convert the first information signal produced by the signal producer into the second information signal.

5. The computer system according to claim 4, wherein the signal producer has an output to transmit a first interrupt signal to the signal converter and the information processor, and the signal converter and the information processor have respective inputs to receive the first information signal from the signal producer when the first interrupt signal is transmitted from the signal producer.

6. The computer system according to claim 4, wherein the information processor has an output to transmit a second interrupt signal to the signal converter when the user's selection input by the mode selection unit corresponds to transmission of the second information signal, and the signal converter has an output to transmit the second information signal to the information processor when the second interrupt signal has been transmitted from the information processor.

7. The computer system according to claim 4, wherein the first information signal is transmitted between the signal producer and the signal converter, and between the signal producer and the information processor according to an Inter-Integrated Circuit (I2C) standard.

8. The computer system according to claim 4, wherein the second information signal is transmitted between the signal converter and the information processor according to a PS/2 standard.

9. The computer system according to claim 1, wherein the manipulation mode comprises a direction key mode and a pointing device mode, and the controller controls the operation performing unit based on the direction information and disregarding the motion amount information when the direction key mode is selected, and controls the operation performing unit based on the direction information and the motion amount information when the pointing device mode is selected.

10. A control method of controlling a computer system including an operation performing unit which performs at least one operation, and a manipulation information producing unit which senses a user's manipulation to thus produce direction information and motion amount information reflecting an amount of motion in a direction corresponding to the direction information, the control method comprising:
determining a manipulation mode selected by the user; and
controlling the operation performing unit based on the direction information and disregarding the motion amount information or based on the direction information and the motion amount information, in accordance with the manipulation mode selected by the user.

11. The control method of claim 10, wherein the manipulation information producing unit outputs a first information signal including the direction information and the motion amount information and a second information signal including the direction information and the motion amount information that has a format different from a format of first information signal, and the operation of controlling comprises controlling the operation performing unit based on the direction information included in the first information signal and disregarding the motion amount information in the first information signal, or controlling the operation performing unit based on the direction information and the motion amount information included in the second information signal.

12. The control method of claim 11, wherein the operation of controlling comprises an operation of receiving the first information signal from the manipulation information producing unit in accordance with an Inter-Integrated Circuit (I2C) standard.

13. The control method of claim 11, wherein the operation of controlling comprises an operation of receiving the second information signal from the manipulation information producing unit in accordance with a PS/2 standard.

14. The control method of claim 12, wherein the operation of controlling further comprises an operation of controlling the manipulation information producing unit so that the second information signal can be selectively transmitted in accordance with the manipulation mode selected by the user.

15. The control method of claim 10, wherein the manipulation mode comprises a direction key mode and a pointing device mode, and the operation of controlling comprises controlling the operation performing unit based on the direction information and disregarding the motion amount information when the direction key mode is selected, and controlling the operation performing unit based on the direction information and the motion amount information when the pointing device mode is selected.

16. A computer comprising:
a pointer device having an input which receives a physical manipulation by a user and having an output of manipulation data including direction information of a direction and information of an amount of the physical manipulation by a user;
an input to receive at least first and second mode selections by a user; and
a controller responsive to the output of the pointer device and the mode selection received by the input, and having an output to control a controlled device in communication with the controller in a first mode when the input receives the first mode selection and to control the controlled device in a second mode when the input receives the second mode selection.

17. The computer of claim 16, wherein the output of the controller includes first information corresponding to the direction information and lacks information of the amount of physical manipulation when in the first mode, and the output of the controller includes second information corresponding to both the direction information and information of an amount of physical manipulation when in the second mode.

18. The computer of claim 17, wherein the output of the controller in the first mode includes the direction information.

19. The computer of claim 16, wherein the controlled device is a display and the computer further comprises:
the display, including an input in communication with the output of the controller, the display responsive to the direction information and unresponsive to the information of an amount of the physical manipulation by a user in the first mode, and the display responsive to both the direction information and the information of an amount of the physical manipulation by a user.

20. The computer of claim 19,
wherein the display includes an input in communication with the output of the controller, and
wherein the output of the controller provides display information to the display, in the first mode, the display information changing a location of a cursor displayed by the display by a predetermined amount in a direction corresponding to the direction information and, in the second mode, the display information changing a location of the cursor displayed by the display from a first position to a second position by an amount corresponding to the information of an amount of the physical manipulation by a user in a direction corresponding to the direction information.

21. The computer of claim 20, wherein in the first mode, the controller receives information regarding the manipulation of the pointer device in accordance with an Inter-Integrated Circuit (I2C) standard, and in the second mode, receives information regarding the manipulation of the pointer device in accordance with a PS/2 standard.

22. The computer of claim 20, further comprising:
first and second buttons; wherein
the controller is responsive to manipulation of the first and second buttons to control the display in a manner consistent with manipulation of left and right buttons of a mouse.

23. The computer of claim 16, wherein the pointer device is one of a track ball, pointing stick, mouse touchpad, light pen, a touchscreen and a digitizing tablet.

24. A method of controlling a display, comprising:
physically interacting with a device;
generating direction information and magnitude information corresponding to the physical interaction of the device; and
in a first mode of operation, altering the display in response to the direction information, and in second mode of operation, altering the display in response to both the direction information and magnitude information, wherein in the first mode, the display is unresponsive to the magnitude information.

25. The method of claim 24, further comprising:
receiving a user input which determines the mode of operation.

26. The method of claim 24, wherein the operation of altering the display includes moving a cursor displayed by the display.

27. The method of claim 26, wherein the operation of altering the display includes, in the first mode, moving the cursor in a direction corresponding to the direction information by a predetermined amount, and in the second mode, moving the cursor in a direction corresponding to the direction information by an amount corresponding to the magnitude information.
